(19) United States
(12) Patent Application Publication
(10) Pub. No.: US 2017/0072692 A1
(43) Pub. Date: Mar. 16, 2017

(54) PRINT FLUID PASSAGEWAY THIN FILM PASSIVATION LAYER

(71) Applicant: HEWLETT-PACKARD DEVELOPMENT COMPANY, L.P., Houston, TX (US)

(72) Inventors: Zhizhang CHEN, Corvallis, OR (US); Tony S CRUZ-URIBE, Corvallis, OR (US)

(73) Assignee: HEWLETT-PACKARD DEVELOPMENT COMPANY, L.P., Houston, TX (US)

(21) Appl. No.: 15/122,715

(22) PCT Filed: Mar. 25, 2014
(86) PCT No.: PCT/US2014/031746

§ 371 Date: Nov. 2, 2016

(51) Int. Cl. B41J 2/14; B41J 2/16

(52) U.S. Cl. CPC B41J 2/14274; B41J 2/1642; B41J 2/1607

(57) ABSTRACT

In an example, a printhead includes a die stack having a plurality of dies and a nozzle plate bonded together. A fluid passageway extends throughout the die stack to enable fluid to flow into a bottom die in the die stack, through the die stack, and out through a nozzle in the nozzle plate. The printhead includes a thin film passivation layer that coats all surfaces of the fluid passageway.

### BACKGROUND

Fluid ejection systems include drop-on-demand inkjet printing devices commonly categorized according to how they eject fluid drops from inkjet printheads. For example, printheads in thermal bubble inkjet printers use heating element actuators to vaporize ink (or other fluids) within ink-filled chambers to create bubbles that force ink droplets out of the printhead nozzles. Printheads in piezoelectric inkjet printers use piezoelectric thin-film or ceramic actuators to generate pressure pulses within ink-filled chambers that force droplets of ink (or other fluid) out of the printhead nozzles.

Piezoelectric printheads are better suited than thermal printheads for ejecting certain fluids, such as UV curable printing inks, whose higher viscosity and/or chemical composition can cause problems in thermal printheads. Thermal printheads are better suited for ejecting fluids whose formulations can withstand boiling temperatures without experiencing mechanical or chemical degradation. In general, ejecting fluid drops from a printhead using pressure pulses rather than vapor bubbles allows piezoelectric printheads to accommodate a wider selection of fluids. However, the use of additional fluids can bring other challenges such as fluids that are more corrosive toward, and/or chemically reactive with internal printhead components (e.g., piezoelectric actuators and electrodes that drive the piezoelectric actuators).

### BRIEF DESCRIPTION OF THE DRAWINGS

Examples are described below, with reference to the accompanying drawings, in which:

FIG. 1 shows an example inkjet printing system suitable for implementing a fluid ejection device that incorporates an ALD (atomic layer deposition) thin film passivation layer coating the inner surfaces of the device;

FIG. 2 shows a partial cross-sectional side view of an example piezoelectric inkjet (PIJ) printhead including an ALD thin film passivation layer that coats the inner surfaces of the printhead;

FIG. 3 shows a partial cross-sectional side view of an example PIJ printhead including an ALD thin film passivation layer that coats the inner and outer surfaces of the printhead;

FIG. 4 shows a flowchart of an example method of fabricating a PIJ printhead that includes an ALD thin film passivation layer 260 that coats surfaces of the printhead;

FIG. 5 shows a perspective view of an example supply device implemented as an inkjet print cartridge that incorporates printheads having an ALD thin film passivation layer that coats the surfaces of the printheads;

FIG. 6 shows a portion of an example supply device implemented as a media-wide print bar that incorporates printheads having an ALD thin film passivation layer that coats the surfaces of the printheads 114.

Throughout the drawings, identical reference numbers designate similar, but not necessarily identical, elements.

### DETAILED DESCRIPTION

State-of-the art piezoelectric ink jet (PIJ) printhead devices utilize a combination of thin film PZT (Lead Zirconate Titanate) actuators and elaborate micro-fluidic components that are fabricated using a mixture of integrated circuit and MEMS (microelectromechanical systems) techniques. These thin film PZT actuators are placed in a substantially hermetic environment within a protective cavity to prevent device degradation from ink and moisture. Various geometries have been used for the actuators themselves, as well as the micro fluidic conduits that route ink from the supply reservoirs into the active firing chambers, and subsequently out of the device as an ejected stream of ink droplets.

As noted above, certain fluids intended for use in piezoelectric printheads can corrode and/or chemically react with internal printhead components, such as the thin film PZT actuators and the electrodes that drive the actuators. Increased physical interaction between the printhead fluid and these components can occur through micro-cracks that form within the printhead structure. The physical interaction between fluids and certain printhead components and can result in damaged or defective printhead nozzles. For example, electrical short circuits resulting from corrosion can degrade the ejection performance of printhead nozzles, and/or render printhead nozzles permanently defective. Over time, as the number of damaged and defective nozzles increases, the overall quality of printed output from the inkjet printing device can suffer.

Example piezoelectric printhead devices described herein incorporate a thin film passivation layer that covers the surfaces throughout the interior of the printheads. A low temperature (≦150 C) ALD (atomic layer deposition) thin film passivation technique is used to apply the thin file passivation layer to the finished MEMS structure, or completed printhead. The passivation layer covers all of the inside surfaces uniformly including the insides of the fluid inlets, the fluid channels, the fluid chambers, and the descenders, all the way to the nozzles in the nozzle plate.

The passivation layer improves nozzle health and enhances piezo-actuator membrane strength and reliability by sealing micro-cracks in the printhead structure and providing chemical resistance to the ink or other fluids. The ALD passivation significantly prevents electrical shorts that can be caused by corrosion due to physical contact between the printhead fluids and active printhead components. This improves nozzle life spans and reduces the number of missing nozzles. The uniformity of the passivation layer also reduces the impact of non-uniform and/or contaminated surfaces by encapsulating dust, dirt, or other matter that can result from the printhead fabrication process. This helps to keep such materials from blocking nozzles and fluid channels during printhead operation, as well as improving surface wetting with low contact angles on all the fluid-surface interfaces. This, in turn, makes the printhead priming process easier and improves the overall fluid/ink flow through the printhead.

In one example, a printhead includes a die stack having a plurality of dies and a nozzle plate bonded together. A fluid passageway extends throughout the die stack to enable fluid to flow into a bottom die in the die stack, through the die stack, and out through a nozzle in the nozzle plate. The printhead includes a thin film passivation layer that coats all surfaces of the fluid passageway.

In another example, a print cartridge includes a piezoelectric printhead defined by a multi-layer die stack. A fluid passageway forms an interior surface area throughout the die stack to enable fluid to flow from a bottom substrate die to a nozzle in a top nozzle plate. A thin film passivation layer covers all of the interior surface areas of the printhead.

In another example, a print bar includes a printhead assembly to support multiple piezoelectric printheads. Each of the multiple printheads has an interior fluid passageway formed throughout multiple layers of a die stack, and the interior fluid passageway in each printhead is coated with a thin film passivation layer on all surface areas. In one implementation, the thin film passivation layer comprises a hafnium oxide (HfO2) layer formed by an atomic layer deposition process.

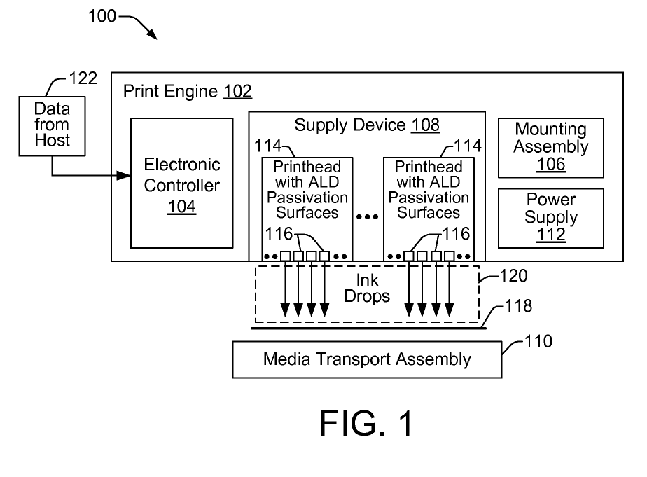

FIG. 1 shows an example inkjet printing system 100 suitable for implementing a fluid ejection device that incorporates an ALD (atomic layer deposition) thin film passivation layer coating the inner surfaces of the device. In some examples, the inkjet printing system 100 comprises a scanning type system where a fluid ejection device (i.e., printhead) with multiple fluid ejecting nozzles is mounted on a carriage that scans back and forth across the width of a print media. The nozzles deposit printing fluid onto the media as the carriage scans back and forth, and the media is incrementally advanced between each scan in a direction perpendicular to the carriage scanning motion. In some implementations, the scanning carriage supports multiple fluid ejection devices. In other examples of an inkjet printing system 100, multiple stationary fluid ejection devices span the width of a print media to deposit printing fluid as the media is continually advanced. Such printing systems include, for example, page-wide printers and wide-format printers having print bars that support the multiple fluid ejection devices across the full width of the print media.

In one example, the inkjet printing system 100 includes a print engine 102 having a controller 104, a mounting assembly 106, replaceable supply devices 108 (e.g., ink cartridges, ink reservoirs, print bars), a media transport assembly 110, and a power supply 112 that provides power to the various electrical components of inkjet printing system 100. The inkjet printing system 100 further includes fluid ejection devices implemented as printheads 114 that eject droplets of ink or other fluid through a plurality of nozzles 116 (also referred to as orifices or bores) toward print media 118 so as to print onto the media 118. In some examples a printhead 114 comprises an integral part of an ink cartridge supply device 108, while in other examples a plurality of printheads 114 can be mounted on a media wide print bar supply device 108 (not shown) supported by mounting assembly 106 and fluidically coupled (e.g., via a tube) to an external fluid supply reservoir (not shown). Print media 118 can be any type of suitable sheet or roll material, such as paper, card stock, transparencies, Mylar, polyester, plywood, foam board, fabric, canvas, and the like.

In one example, a printhead 114 comprises a piezoelectric inkjet printhead that generates pressure pulses with a piezoelectric material actuator to force ink droplets out of a nozzle 116. In an example implementation, the printhead 114 comprises a multi-layer structure composed of a large array of piezo-driven nozzles 116, capable of achieving high-speed printing in an industrial printing environment. Printhead 114 is on the order of several millimeters in thickness and can have varying shapes with varying lengths and widths. Nozzles 116 are typically arranged along the printhead 114 in columns or arrays such that properly sequenced ejection of ink from the nozzles 116 causes characters, symbols, and/or other graphics or images to be printed onto the print media 118 as the printhead 114 and print media 118 are moved relative to each other.

Mounting assembly 106 positions printheads 114 relative to media transport assembly 110, and media transport assembly 110 positions print media 118 relative to the printheads 114. Thus, a print zone 120 is defined adjacent to nozzles 116 in an area between printheads 114 and print media 118. In one example, print engine 102 comprises a scanning type print engine. As such, mounting assembly 106 includes a carriage for moving printheads 114 relative to media transport assembly 110 to scan print media 118. In another example, the print engine 102 comprises a non-scanning type print engine that can include a single-pass, page-wide array of printheads 114. As such, mounting assembly 106 fixes printheads 114 at a prescribed position relative to media transport assembly 110 while media transport assembly 110 positions print media 118 relative to printheads 114.

Electronic controller 104 typically includes components of a standard computing system such as a processor, memory, firmware, and other printer electronics for communicating with and controlling supply device 108, printhead 114, mounting assembly 106, and media transport assembly 110. Electronic controller 104 receives data 122 from a host system, such as a computer, and temporarily stores the data 122 in a memory. Data 122 represents, for example, a document and/or file to be printed. As such, data 122 forms a print job for inkjet printing system 100 that includes print job commands and/or command parameters. Using data 122, electronic controller 104 controls printhead 114 to eject ink drops from nozzles 116 in a defined pattern that forms characters, symbols, and/or other graphics or images on print medium 118.

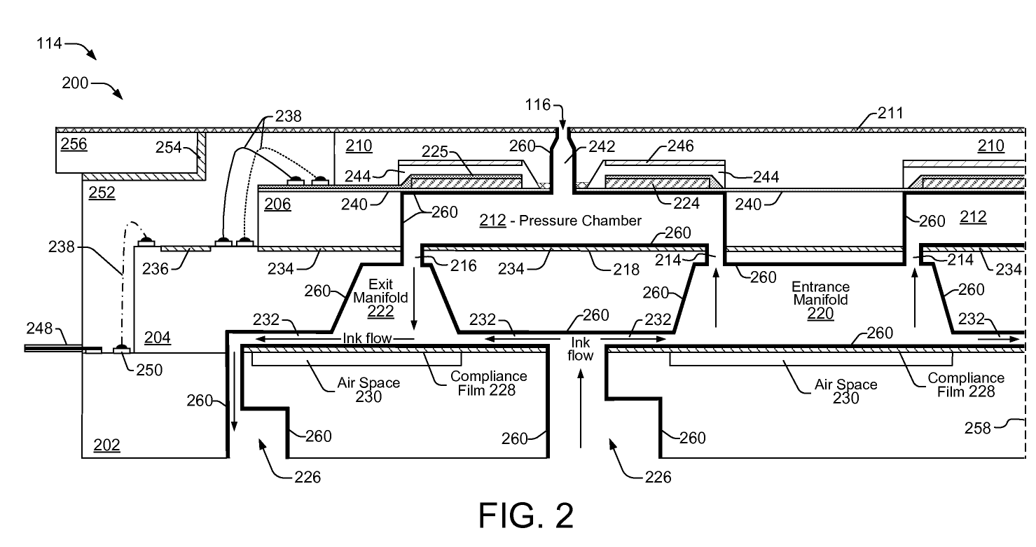

FIG. 2 shows a partial cross-sectional side view of an example piezoelectric ink jet (PIJ) printhead 114 including an ALD (atomic layer deposition) thin film passivation layer that coats the inner surfaces of the printhead 114. In this example, the PIJ printhead 114 comprises a piezoelectric die stack 200 with an integrated nozzle plate and cap structure 210. More specifically, the layers in the die stack 200 include a first (i.e., bottom) substrate die 202, a second circuit die 204 (or ASIC die), a third actuator/chamber die 206, and a fourth integrated nozzle plate and cap structure 210. However, the printhead 114 is not limited in this regard, and other die stack and nozzle plate configurations are possible and contemplated herein. For example, in other implementations the nozzle plate and cap structure 210 may be separate structures that are adhered or otherwise affixed to one another. Furthermore, in other examples of a PIJ printhead 114 there can be different PIJ die stack schemes in which the circuit die 204 is not part of the die stack 200, but is instead located near the die stack and coupled to the die stack through wire bond connections. In one example, printhead 114 also includes a non-wetting layer 211 on a top surface of the integrated nozzle plate and cap structure 210. Non-wetting layer 211 comprises a hydrophobic coating to help prevent ink from puddling around nozzles 116. In general, the multiple die layers in the example PIJ printhead 114 get narrower from the bottom die to the top die (i.e., from die 202 to die 206), and each die layer enables different functionality within the printhead 114.

Each layer in the die stack 200, except for the integrated nozzle plate and cap structure 210 and the non-wetting layer 211, is typically formed of a semiconductor material such as silicon, germanium, or glass. In addition, these semiconductor layers each generally comprise an assortment of patterned thin films. The integrated nozzle plate and cap structure 210 is typically formed of SU8 or another viscous polymer. The layers are bonded together with a chemically inert adhesive such as an epoxy (not shown). In the illustrated example, the die layers form a fluid passageway that includes fluid entry ways, fluid ports, pressure chambers, fluid manifolds, fluid channels, holes, descenders, and nozzles, for conducting ink or other fluid through the die stack 200, to and from pressure chambers 212, and out through nozzles 116. Each pressure chamber 212 may include two fluid ports (inlet port 214, outlet port 216) located in the floor 218 of the chamber (i.e., opposite the nozzle-side of the chamber) that are in fluid communication with an ink distribution manifold (entrance manifold 220, exit manifold 222). The floor 218 of the pressure chamber 212 is formed by the surface of the circuit layer 204. The two fluid ports (214, 216) are on opposite sides of the chamber floor 218 where they pierce, or form holes in, the circuit layer 204 die and enable ink to be circulated through the chamber 212. The piezoelectric actuators 224 are disposed on a flexible membrane 240. Flexible membrane 240 is located opposite the chamber floor 218 and serves as a roof to the chamber 212. Thus, the piezoelectric actuators 224 are located on the same side of the chamber 212 as are the nozzles 116 (i.e., on the roof or top-side of the chamber).

The bottom substrate die 202 includes fluidic entry ways 226 through which ink is able to flow to and from pressure chambers 212 via the ink distribution manifold (entrance manifold 220, exit manifold 222). In some examples, substrate die 202 supports a thin compliance film 228 with an air space 230 configured to alleviate pressure surges from pulsing ink flows through the ink distribution manifold due to start-up transients and ink ejections in adjacent nozzles, for example.

Circuit die 204 is the second die in die stack 200 and is located above the substrate die 202. In the example shown in FIG. 2, circuit die 204 is adhered to substrate die 202 and is narrower than the substrate die 202. In other examples, the circuit die 204 may also be shorter in length than the substrate die 202. Circuit die 204 includes the ink distribution manifold that comprises ink entrance manifold 220 and ink exit manifold 222. Entrance manifold 220 provides ink flow into chamber 212 via inlet port 214, while outlet port 216 allows ink to exit the chamber 212 into exit manifold 222. In some examples, circuit die 204 includes fluid bypass channels 232 that permit some of the ink coming into entrance manifold 220 to bypass the pressure chamber 212 and flow directly into the exit manifold 222 through the bypass 232. Bypass channels 232 create an appropriately sized flow restrictor that narrows the channel so that desired ink flows are achieved within pressure chambers 212 and so that sufficient pressure differentials between chamber inlet ports 214 and outlet ports 216 are maintained.

Circuit die 204 also includes CMOS electrical circuitry 234 which can be implemented, for example, in an ASIC (application specific integrated circuit) 234. ASIC 234 is fabricated on the upper surface of circuit die 204, adjacent the actuator/chamber die 206. ASIC 234 includes ejection control circuitry that controls the pressure pulsing (i.e., firing) of piezoelectric actuators 224 with signals through conductive electrodes 225. At least a portion of ASIC 234 is located directly on the floor 218 of the pressure chamber 212. Because ASIC 234 is fabricated on the chamber floor 218, it can come in direct contact with ink inside pressure chamber 212. However, ASIC 234 is buried under a thin film passivation layer 260 (discussed below) that includes a dielectric material to provide insulation and protection from the ink within chamber 212. In some examples, ASIC 234 includes temperature sensing resistors (TSR) and heater elements, such as electrical resistance films. The TSR's and heaters in ASIC 234 are configured to maintain the temperature of the ink within the chamber 212 at a desired and uniform level that is favorable to the ejection of ink drops through nozzles 116.

In some examples, circuit die 204 includes piezoelectric actuator drive circuitry/transistors 236 (e.g., FETs) fabricated on the edges of the die 204 outside of bond wires 238 (discussed below). Thus, drive transistors 236 are on the same circuit die 204 as the ASIC 234 control circuits and are part of the ASIC 234. Drive transistors 236 are controlled (i.e., turned on and off) by control circuitry in ASIC 234. The performance of pressure chamber 212 and piezoelectric actuators 224 is sensitive to changes in temperature, and having the drive transistors 236 out on the edges of circuit die 204 keeps heat generated by the transistors 236 away from the chamber 212 and the actuators 224.

The next layer in die stack 200 located above the circuit die 204 is the actuator/chamber die 206 (“actuator die 206”, hereinafter). The actuator die 206 is adhered to circuit die 204 and it is narrower than the circuit die 204. In some examples, the actuator die 206 may also be shorter in length than the circuit die 204. Actuator die 206 includes pressure chambers 212 having chamber floors 218 that comprise the adjacent circuit die 204. As noted above, the chamber floor 218 additionally comprises control circuitry such as ASIC 234 fabricated on circuit die 204 which forms the chamber floor 218. Actuator die 206 additionally includes a thin-film, flexible membrane 240 such as silicon dioxide, located opposite the chamber floor 218 that serves as the roof of the chamber. Above and adhered to the flexible membrane 240 is piezoelectric actuator 224. Piezoelectric actuator 224 comprises a stack of thin-film piezoelectric, conductor, and dielectric materials that stresses mechanically in response to electrical voltages applied via conductive electrodes 225. When activated, piezoelectric actuator 224 physically expands or contracts which causes the laminate of piezoceramic and membrane 240 to flex. The flexing of membrane 240 displaces ink within the pressure chamber 212, generating pressure waves in the chamber that eject ink drops through the nozzle 116. In the example shown in FIG. 2, both the flexible membrane 240 and the piezoelectric actuator 224 are split by a descender 242 that extends between the pressure chamber 212 and nozzle 116. Thus, piezoelectric actuator 224 comprises a split piezoelectric actuator 224 having a segment on each side of the chamber 212.

The integrated nozzle plate and cap structure 210 is adhered above the actuator die 206. The integrated structure 210 may be narrower than the actuator die 206, and in some examples it may also be shorter in length than the actuator die 206. The integrated structure 210 forms a cap cavity 244 over the piezoelectric actuator 224 that encloses the actuator 224. The cavity 244 is a sealed cavity that protects the actuator 224. Although the cavity 244 is not vented, the sealed space it provides includes sufficient open volume and clearance to permit the piezoactuator 224 to flex without influencing the motion of the actuator 224. The cap cavity 244 may have a ribbed upper surface 246 opposite the actuator 224 that increases the volume of the cavity and surface area (for increased adsorption of water and other molecules deleterious to the thin film pzt long term performance). The ribbed surface 246 is designed to strengthen the upper surface of the cap cavity 244 so that it can better resist damage from handling and servicing of the printhead (e.g., wiping). The ribbing helps reduce the thickness of the integrated nozzle plate and cap structure 210 and shorten the length of the descender 242.

The integrated nozzle plate and cap structure 210 also includes the descender 242. The descender 242 is a channel through the integrated structure 210 that extends between the pressure chamber 212 and nozzle 116 (also referred to as orifice or bore), enabling ink to travel from the chamber 212 and out of the nozzle 116 during ejection events caused by pressure waves generated by actuator 224. As noted above, in the FIG. 2 example, the descender 242 and nozzle 116 are centrally located in the chamber 212, which splits the piezoelectric actuator 224 and flexible membrane 240 between two sides of the chamber 212. Nozzles 116 are formed in the integrated structure 210.

As noted above, the example PIJ printhead 114 shown in FIG. 2 includes an ALD (atomic layer deposition) thin film passivation layer 260 that coats the inner surfaces of the printhead 114. In one example, the thin film passivation layer 260 is applied to the fully fabricated printhead 114 using a low temperature (e.g., ≦150 Celsius) ALD technique. That is, the passivation layer 260 is applied to the printhead 114 after all of the layers and components of the piezoelectric die stack 200 and integrated nozzle plate and cap structure 210 have been fabricated and integrated together to form the completed printhead 114.

The ALD applied thin film passivation layer 260 comprises a protective dielectric layer that can be formed of various dielectric materials including, for example, hafnium oxide (HfO2), zirconium dioxide (ZrO2), aluminum oxide (Al2O3), titanium oxide (TiO2), hafnium silicon nitride (HfSi3N4), silicon oxide (SiO2), silicon nitride (Si3N4), and so on. Among other things, use of the low temperature ALD technique to form the passivation layer 260 avoids degradation of the integrated nozzle plate and cap structure 210, which as noted above is typically formed of an SU8 viscous polymer.

As shown in FIG. 2, the thin film passivation layer 260 is deposited throughout the interior of the printhead 114 and coats or covers the entire fluidic passageway formed within the die stack 200 by the fluid entry ways, fluid ports, pressure chambers, fluid manifolds, fluid channels, holes, descenders, and nozzles. Thus, the passivation layer 260 covers or coats all of the interior surfaces of the printhead 114 including all vertical and horizontal surfaces, which include, for example, the interior walls of the nozzle 116, the walls of the descender 242, the side, top, and bottom walls of the chambers 212, the walls of the fluid ports (i.e., inlet port 214 and outlet port 216), the walls of the entrance manifold 220 and exit manifold 222, the walls of the fluid bypass channels 232, and the walls of the fluidic entry ways 226.

The thin film passivation layer 260 helps to improve the health and duration of each nozzle in general, by sealing micro-cracks formed in the surfaces and strengthening the surfaces to provide resistance against the corrosive and/or chemically reactive effects of the fluid ink. For example, the passivation layer 260 seals and strengthens the flexible membrane 240 that forms the top surface (or roof) and supports the piezoelectric actuators 224. Thus, the passivation layer 260 helps keep corrosive ink from entering the protective cavity 244 and physically contacting the piezoelectric actuators 224 and conductive electrodes 225.

In addition, the thin film passivation layer 260 is a uniform film that is applied one molecular layer at a time to the surfaces of the fabricated printhead 114 through the ALD process. The uniform surface of the passivation layer 260 reduces the impact of non-uniform and/or contaminated printhead surfaces by encapsulating dust, dirt, or other matter that can result from the printhead fabrication process. Contaminants and other matter are therefore sealed in by the layer 260 which prevents them from blocking nozzles and fluid channels during printhead operation. The uniformity of the passivation layer 260 also improves surface wetting with low contact angles on fluid-surface interfaces, which makes the printhead priming process easier and improves the overall fluid/ink flow through the printhead 114.

The uniformity of the passivation layer 260 is a result of the low temperature ALD process used to form the layer 260. The ALD process is performed after fabrication of the printhead 114 has been completed, and the process generally involves the sequential and repeated deposition of two different chemical precursors. The precursors react one at a time, in a sequential manner, with surfaces of the printhead 114. The reaction of each precursor with the surfaces of the printhead is self-limiting, and repeated exposure of the surfaces to the gas phase chemical precursors builds up the thin film passivation layer 260 in a uniform manner. In some examples, the thin film passivation layer is on the order of 200 angstroms in thickness. Each exposure cycle of the printhead surfaces to the two gas phase chemical precursors adds one molecular layer, approximately 1 angstrom in thickness, to the thin film passivation layer 260. Accordingly, in some examples, the ALD process is cycled through approximately 200 times to achieve a passivation layer 260 on the order of 200 angstroms in thickness.

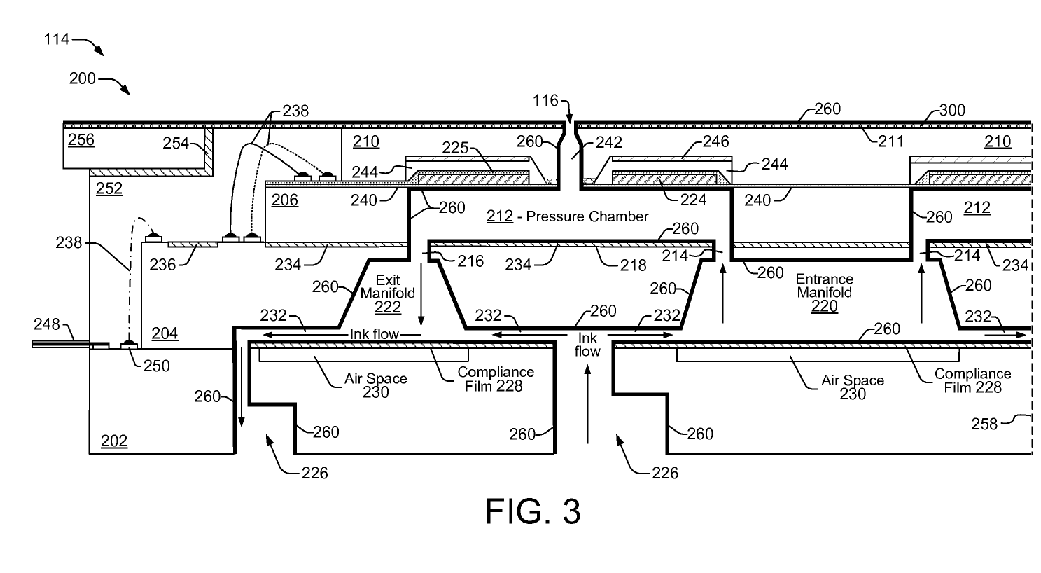

In some examples, the ALD applied thin film passivation layer 260 coats both the inside and outside surfaces of the PIJ printhead 114. This can be the result of the general ALD process, in which the fabricated printhead 114 is placed within a chamber that is repeatedly infused with the gas phase chemical precursors in a sequential manner as noted above. The chemical precursors react with the outer surfaces of the printhead 114 as well as with the inner surfaces. Thus, as shown in FIG. 3, in some examples the printhead 114 includes an outer surface 300 coated with the thin film passivation layer 260. In this example, in addition to the inner surfaces of the printhead 114 being coated, the non-wetting layer 211 on the top/outer surface 300 of the integrated nozzle plate and cap structure 210 has also been coated with the thin film passivation layer 260.

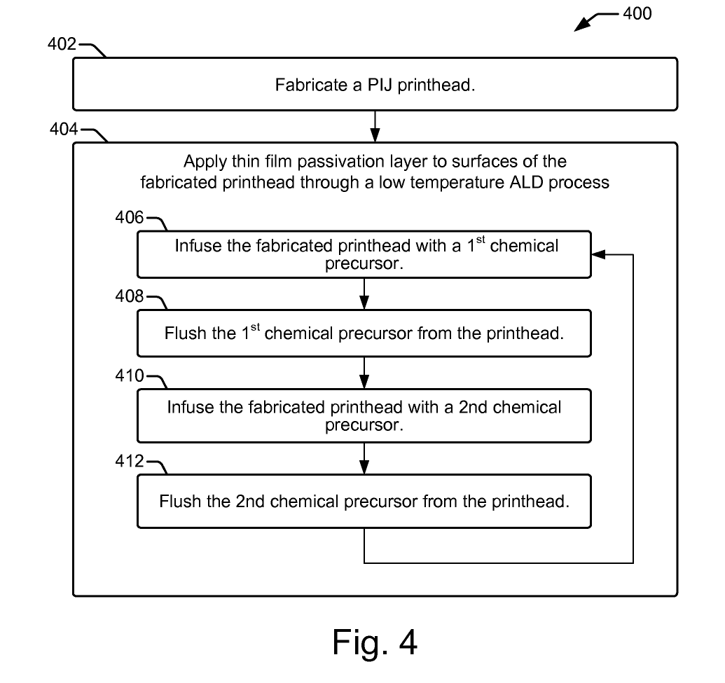

FIG. 4 shows a flowchart of an example method of fabricating a PIJ printhead 114 that includes an ALD (atomic layer deposition) thin film passivation layer 260 that coats the surfaces of the printhead 114. The example method 400 is associated with the examples discussed herein with respect to FIGS. 1-3, and FIGS. 5-6. The method 400 begins at block 402 with fabricating a PIJ printhead 114. The details of fabricating the PIJ printhead 114 are not described herein, but in general include forming each of the layers of the die stack 200 along with their respective fluid passageways (e.g., channels, ports, manifolds, chambers) and patterned thin films, forming the integrated nozzle plate and cap structure 210 (e.g., of SU8 or another viscous polymer), and bonding the layers together to form the PIJ printhead 114 as generally described above with respect to FIG. 2. After the printhead 114 fabrication is complete, the method 400 continues at block 404 with applying a thin film passivation layer to all of the inner surfaces of the fabricated printhead through a low temperature ALD process. In some examples, the thin film passivation layer can also be applied to outer surfaces of the fabricated printhead. The ALD process comprises the application of two gas phase chemicals in a sequential and repetitive manner to surfaces of the printhead 114 to build up the thin film passivation layer.

In one example, the low temperature ALD process includes infusing the fabricated printhead with a 1^{st} chemical precursor, as shown at block 406. The 1^{st} chemical precursor can comprise, for example, gas phases of hafnium, zirconium, aluminum, titanium, and silicon. Infusing the printhead with a precursor can include placing the printhead within a chamber and bringing the printhead to a particular temperature such as 150 degrees Celsius or below. The chamber can then be filled with a gas phase of the chemical precursor to infuse the printhead. The method can then continue with flushing the 1st chemical precursor from the chamber and the printhead, as shown at block 408. As shown at block 410, the method 400 can continue with infusing the fabricated printhead with a 2^{nd} chemical precursor in the same manner as the 1^{st} chemical precursor. The 2^{nd} chemical precursor can comprise, for example, oxygen or a nitride. The method can then continue with flushing the 2^{nd} chemical precursor from the chamber and the printhead, as shown at block 412. The infusion and flushing of the 1^{st} and 2^{nd} chemical precursors comprises a single ALD cycle in which one molecular layer of the thin film passivation layer 260, approximately 1 angstrom in thickness, is formed on the printhead surfaces. Thus, as shown in the flowchart of FIG. 4, the method 400 can be repeated to build up additional layers of the passivation layer 260 to a desired thickness. As noted above, in one example the thin film passivation layer is on the order of 200 angstroms in thickness, which would involve performing the method 400 approximately 200 times, to achieve 200 ALD cycles.

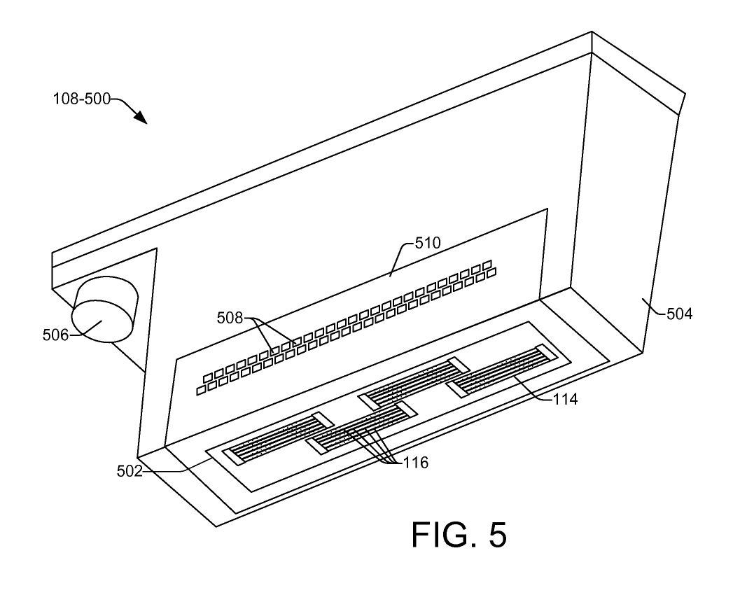

FIG. 5 shows a perspective view of an example supply device 108 implemented as an inkjet print cartridge 500 that incorporates printheads 114 comprising an ALD thin film passivation layer 260 that coats the surfaces of the printheads 114. The print cartridge 500 is an example of a supply device 108 that is suitable for use in a scanning-type inkjet printing device 100. In this example, the print cartridge 500 includes a printhead assembly 502 supported by a cartridge housing 504. The cartridge housing 504 can contain a printing fluid such as ink. The printhead assembly 502 includes four printheads 114 arranged in a row lengthwise across the assembly 502 in a staggered configuration in which each printhead 114 overlaps an adjacent printhead. Although four printheads 114 are shown in the staggered configuration of printhead assembly 502, in other examples there may be more or fewer printheads 114 used in the same or a different configuration.

Print cartridge 500 is fluidically connected to an ink supply (not shown) through an ink port 506 to enable replenishment of ink within the housing 504. Print cartridge 500 is electrically connected to a controller 104 (FIG. 1) through electrical contacts 508. Contacts 508 are formed in a flex circuit 510 affixed to the housing 504. Signal traces (not shown) embedded within flex circuit 510 connect contacts 508 to corresponding contacts (not shown) on each printhead 114. Ink ejection nozzles 116 on each printhead 114 are exposed through an opening in the flex circuit 510 along the bottom of the cartridge housing 504.

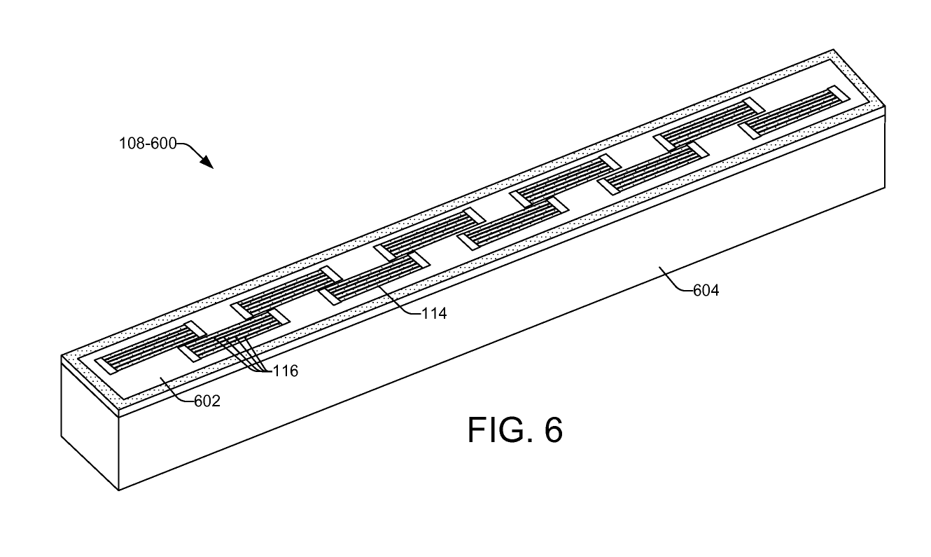

FIG. 6 shows a portion of an example supply device 108 implemented as a media-wide print bar 600 that incorporates printheads 114 comprising an ALD thin film passivation layer 260 that coats the surfaces of the printheads 114. The media-wide print bar 600 is an example of a supply device 108 that is suitable for use in a page-wide or wide-format inkjet printing device 100. In this example, the print bar 600 supports a printhead assembly 602 that includes multiple printheads 114. Although not specifically illustrated, in some examples a print bar 600 can incorporate additional components such as a printed circuit board, a die carrier, a manifold, fluid chambers, and so on. Such components are generally illustrated in FIG. 6 by housing 604.

In some examples, as shown in FIG. 6, multiple printheads 114 can be arranged in a row, lengthwise across the print bar 600 in a staggered configuration in which each printhead 114 overlaps an adjacent printhead 114. Although ten printheads 114 are shown in a staggered configuration, other examples of print bars 600 can incorporate more or fewer printheads 114 in the same or a different configuration.

What is claimed is:

1. A printhead comprising:
a die stack having a plurality of dies and a nozzle plate bonded together;
a fluid passageway extending throughout the die stack that enables fluid to flow into a bottom die in the die stack, through the die stack, and out through a nozzle in the nozzle plate; and
a thin film passivation layer that coats all surfaces of the fluid passageway.

2. A printhead as in claim 1, wherein the thin film passivation layer comprises an atomic layer deposition (ALD) thin film layer.

3. A printhead as in claim 1, wherein the thin film passivation layer comprises material selected from the group consisting of hafnium oxide (HfO2), zirconium dioxide (ZrO2), aluminum oxide (Al2O3), titanium oxide (TiO2), hafnium silicon nitride (HfSi3N4), silicon oxide (SiO2), silicon nitride (Si3N4).

4. A printhead as in claim 1, wherein the thin film passivation layer comprises a plurality of single molecule layers formed one-at-a-time in an atomic layer deposition (ALD) process.

5. A printhead as in claim 1, comprising:
an outer surface; and
a non-wetting layer on the outer surface;
wherein the thin film passivation layer also coats the non-wetting layer on the outer surface.

6. A printhead as in claim 1, wherein the die stack comprises:
a circuit die stacked on a substrate die;
a piezoelectric actuator die stacked on the circuit die; and
a cap die stacked on the piezoelectric actuator die;
wherein each die in succession from the circuit die to the cap die is narrower than a previous die.

7. A printhead as in claim 6, further comprising:
a pressure chamber in the piezoelectric actuator die;
an entrance manifold and inlet port in the circuit die to supply ink to the pressure chamber;
an exit manifold and outlet port in the circuit die to allow ink to exit the pressure chamber; and
a bypass channel between the entrance and exit manifolds to enable ink to bypass the pressure chamber.

8. A printhead as in claim 7, further comprising:
a cap cavity formed in the cap die to protect a piezoelectric actuator; and
a ribbed upper surface in the cap cavity opposite the piezoelectric actuator.

9. A printhead as in claim 8, wherein the piezoelectric actuator comprises a thin film PZT (lead zirconate titanate) actuator formed on a flexible membrane adjacent to the pressure chamber, the flexible membrane to flex into the pressure chamber in response to activation of the piezoelectric actuator.

10. A printhead as in claim 8, further comprising:
a pressure chamber in the piezoelectric actuator die;
a floor to the pressure chamber that comprises an ASIC control circuit; and
a descender in the cap die opposite the floor of the pressure chamber to provide fluid communication between the pressure chamber and the nozzle.

11. A printhead as in claim 10, wherein the piezoelectric actuator comprises a split piezoelectric actuator having a first actuator segment on one side of the descender and a second actuator segment on another side of the descender.

12. A print cartridge comprising:
a piezoelectric printhead defined by a multi-layer die stack;
a fluid passageway forming an interior surface area throughout the die stack to enable fluid to flow from a bottom substrate die to a nozzle in a top nozzle plate; and
a thin film passivation layer covering all of the interior surface area.

13. A print cartridge as in claim 12, comprising:
a printhead assembly having multiple piezoelectric printheads; and
a housing to contain a printing fluid and to support the printhead assembly.

14. A print bar comprising:
a printhead assembly to support multiple piezoelectric printheads, each printhead having an interior fluid passageway formed throughout multiple layers of a die stack;
wherein the interior fluid passageway in each printhead is coated with a thin film passivation layer on all surface areas.

15. A print bar as in claim 14, wherein the thin film passivation layer comprises a hafnium oxide (HfO2) layer formed by an atomic layer deposition process.
